(19) United States
(12) Patent Application Publication
(10) Pub. No.: US 2005/0239022 A1
(43) Pub. Date: Oct. 27, 2005

(54) Method and system for master teacher knowledge transfer in a computer environment

(76) Inventors: William G. Harless, Bethesda, MD (US); Michael G. Harless, Rockville, MD (US); Marcia A. Zier, Bethesda, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/103,079

(22) Filed: Apr. 11, 2005

Related U.S. Application Data
(63) Continuation-in-part of application No. 10/438,168, filed on May 13, 2003.

(51) Int. Cl. G09B 1/00

(52) U.S. Cl. 434/167; 434/350

(57) ABSTRACT

A method for providing knowledge transfer between a Master Teacher and a student. The method includes: providing a prompting question to the student, wherein the prompting question is selected from one or more knowledge transfer questions; receiving an utterance from the student; determining if a match exists between the utterance and the prompting question; and if a match exists, playing a knowledge transfer content sequence associated with the matched prompting question.

### CROSS REFERENCE TO RELATED APPLICATION

This patent application is a continuation-in-part and claims the benefit of priority of U.S. patent application Ser. No. 10/438,168, entitled “Method and System for Simulated Interactive Conversation”, filed May 13, 2003, which is incorporated herein by reference. This application was filed simultaneously with U.S. patent application Ser. No. ______, entitled “Method and System for Master Teacher Testing in a Computer Environment,” which is incorporated herein by reference.

### TECHNICAL FIELD

The invention relates to the field of computerized education, and, more specifically, a system and method that allows teachers in a computerized environment to engage in direct dialogue with students to transfer knowledge content.

### BACKGROUND

Technology has become an important factor in higher education. Schools have emerged and gained accreditation with curricula delivered to students over the Internet. This form of education is variously known as “distance learning” or “E-learning” or “On-line learning.” Students enrolled in these programs can obtain diplomas, undergraduate, and graduate degrees, often fully accredited, without ever setting foot in a classroom or on a campus. Also, these students may be awarded diplomas and degrees without ever having any personal association with a teacher or the faculty, and likely would not know them if they saw them. In effect, the on-line education industry provides an extremely depersonalized form of education, and, without exception, all current computer network-driven learning models share the same deficiency: the absence of face-to-face contact with the teacher.

Many problems also exist in on-campus higher education today. Enrollment has grown exponentially with the maturation of the baby boomer generation. Classrooms are crowded and teachers are scarce; the classroom lectures that are not conducted by superior teachers are inefficient as a learning methodology—students are passive, bored, and subject to numerous distractions during the lecture. The faculty/student ratios are diminished, and the skills, talents, and knowledge of university teachers are not consistent across schools.

Therefore, the transfer of knowledge from faculty to student is unequal. As a result, the quality of education is suffering; educators and administrators must struggle to maintain educational standards. The problems on the conventional campuses represent a “foot hold” for on-line learning, the development of which is rapidly increasing throughout curricula at all levels of education. But, implementation of on-line learning capabilities on campus also de-personalizes the student's education.

A virtual dialog learning paradigm could enhance the educational quality of both on- and off-campus programs. Since the educational objective of virtual lecture is to capture the knowledge and experiences of real teachers and make them available to anyone who is interested through a direct, face-to-face interview, the virtual dialog learning paradigm uniquely embodies the much-desired capability of personalizing the computerized learning process.

Potentially, a virtualized dialog could transform formal education from a crowded lecture hall to individualized, face-to-face knowledge transfer sessions between each student and the instructor. Every student could learn the material from the master teacher, who would be in cyberspace available for conversations with anyone at anytime, or even everyone at the same time.

The present invention addresses one or more of the above problems and is directed to achieving at least one of the above stated goals.

### SUMMARY OF THE INVENTION

A method for providing a knowledge transfer dialogue between a Master Teacher and a student is provided. The method includes: providing a prompting question to the student, wherein the prompting question is selected from one or more knowledge transfer questions; receiving an utterance from the student; determining if a match exists between the utterance and the prompting question; and if a match exists, playing a knowledge transfer content sequence associated with the matched prompting question.

A system for providing knowledge transfer between a Master Teacher and a student is provided. The system includes a display for displaying the Master Teacher; a memory; and a processor, coupled to the memory and the display. The processor is operable to: provide a prompting question to the student, wherein the prompting question is selected from one or more knowledge transfer questions; receive an utterance from the student; determine if a match exists between the utterance and the prompting question; and if a match exists, playing a knowledge transfer content sequence associated with the matched prompting question.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate a system consistent with the invention and, together with the description, serve to explain the principles of the invention.

FIG. 1 is an illustration of a system consistent with the present invention in its operating environment.

FIG. 2 is a block diagram of a knowledge transfer platform 110 consistent with the present invention.

FIG. 3 is a block diagram of an authoring platform 300 consistent with the present invention.

FIG. 4a is an illustration of a display screen at a prompting state consistent with the present invention.

FIG. 4b is an illustration of a display screen during a show questions state consistent with the present invention.

FIG. 4c is an illustration of a display screen at a lecturette state consistent with the present invention.

FIG. 5 is a flowchart of an author process and a student interaction process consistent with the present invention.

FIG. 6 is a flowchart of a video editing process consistent with the present invention.

FIG. 7 is a flowchart of a phoneme generating process consistent with the present invention.

FIG. 8 is a flowchart of a first partial parsing process consistent with the present invention.

FIG. 9 is a flowchart of a second partial parsing process consistent with the present invention.

FIG. 10 is a flowchart of a first meaning-based process consistent with the present invention.

FIG. 11 is a flowchart of a second meaning-based process consistent with the present invention.

FIG. 12 is a flowchart of a knowledge transfer process consistent with the present invention.

### DETAILED DESCRIPTION

Reference will now be made in detail to the present exemplary embodiments consistent with the invention, examples of which are illustrated in the accompanying drawings. Wherever possible, the same reference numbers will be used throughout the drawings to refer to the same or like parts.

The applicants' patent application referenced above and entitled, “Method and System for Simulated Interactive Conversation,” provides a method of simulating interactive communications between a student and a human Master Teacher. The additional disclosure material provided in this continuation-in-part application leverages and improves upon the teachings of the aforementioned application to provide an interactive teaching environment using a “Master Teacher.” Master Teacher is the term used to denote the simulated teacher persona with whom the student interacts when using the system described. Systems consistent with the present invention may provide a new educational paradigm using the Master Teacher and a method where knowledge gain may be accelerated, grades may improve, and educational standards may be elevated. Systems consistent with the present invention are directed to achieving one or more of these goals.

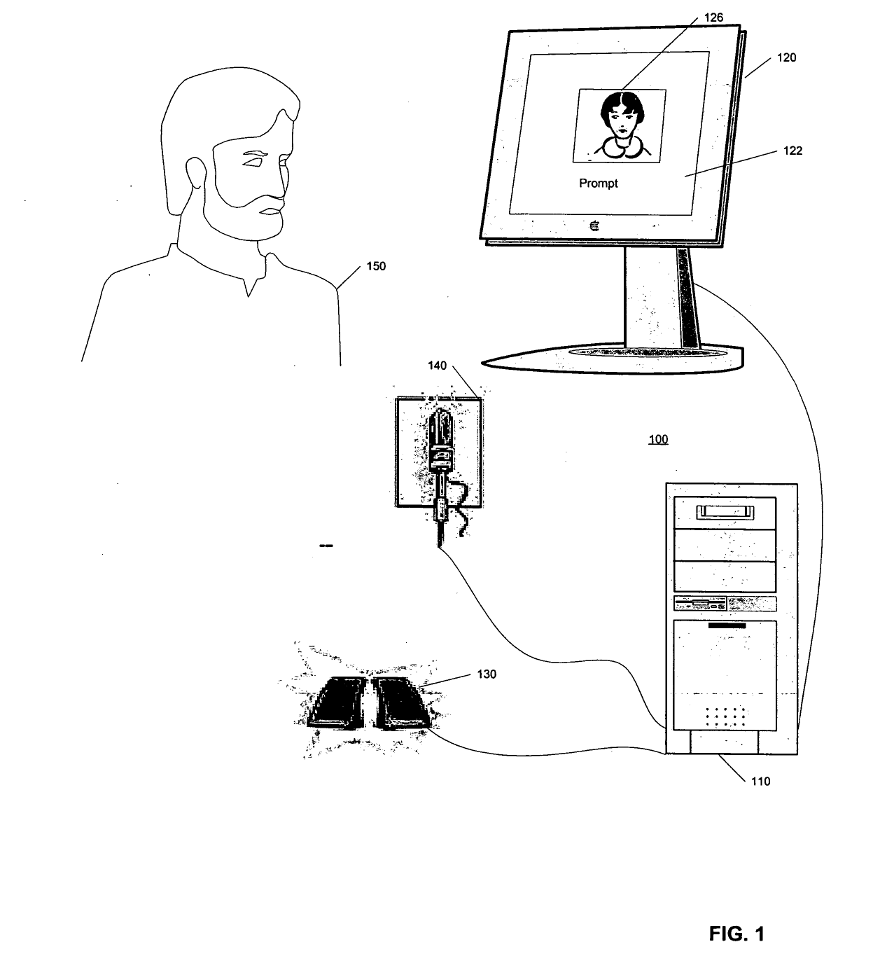

FIG. 1 is an illustration of a system consistent with the present invention in its operating environment. As shown in FIG. 1, a student 150 may interact with a system 100 to conduct a simulated natural conversation with a video display of a Master Teacher 126. Master Teacher 126 preferably is a full motion video image of an actual person. System 100 may comprise a knowledge transfer platform 110, a microphone 140 connected to knowledge transfer platform 110, one or more speakers 130 connected to knowledge transfer platform 110, and a display 120 connected to knowledge transfer platform 110. Student 150, speaking through microphone 140 and listening through speakers 130 may engage in simulated conversation with Master Teacher 126 in a natural, conversational tone without any requirement to “train” the system 100 in the speech patterns of student 150.

Student 150 engages in learning information from the Master Teacher. Student 150 may be provided with one or more prompts 122, for example, a set of three relevant questions displayed one question at a time for a period of time. Student 150 has many options during the knowledge transfer dialogue, including, for example, requesting that system 100 display a screen listing available questions beyond the three scrolling questions 122. Student 150 may also halt the conversation or request a lecturette (a brief lecture from the Master Teacher that continues without interaction from student 150.

As student 150 speaks one of the prompts 122 into microphone 140, knowledge transfer platform 110 may receive this utterance as audio signals from microphone 140, parse the audio signals, compare the parsed audio signals to a database of phonemes to find a matching phrase, and takes the appropriate action, for example, playing a content sequence of the Master Teacher responding to the question.

Consistent with the present invention, one or more authoring processes may also be provided to permit authoring of knowledge transfer content sequences to be engaged in by student 150. The authoring processes may include a video editing process for generating knowledge transfer content sequences and associated prompting questions; and a phoneme generation process to generate phonetic “clones” of prompting questions for storage in the database to match the prompting questions.

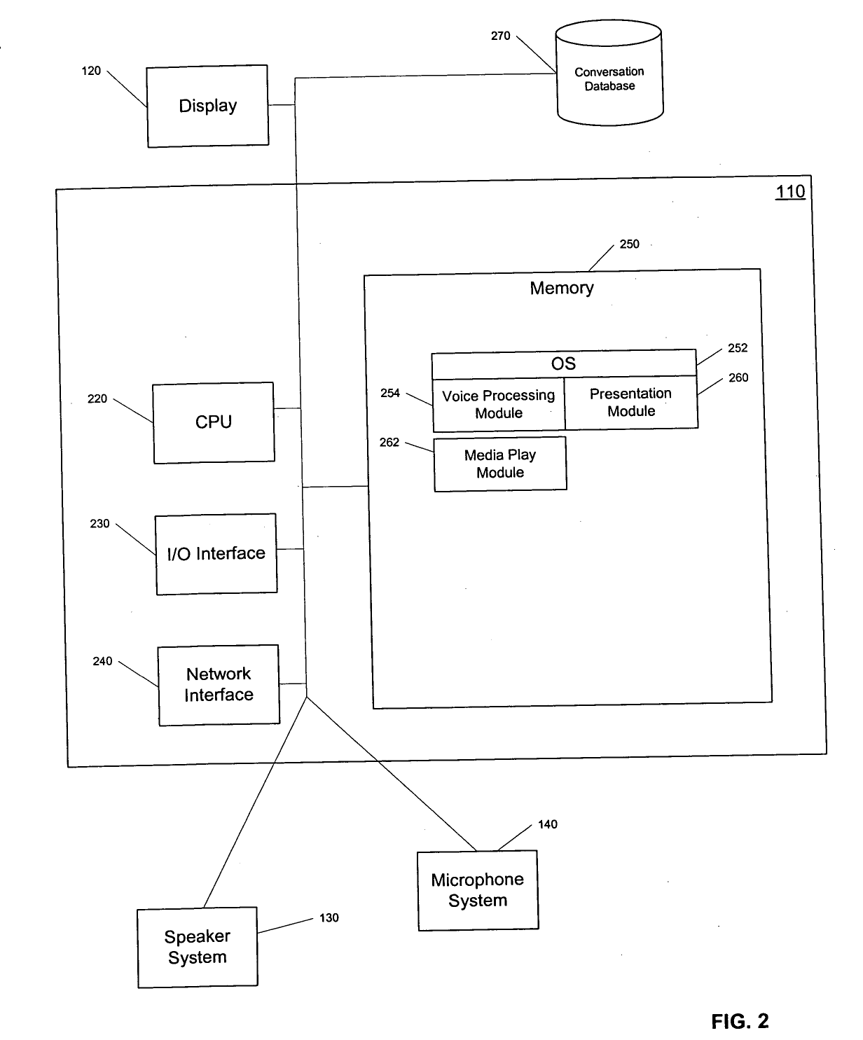

FIG. 2 is a block diagram of a knowledge transfer platform 110 consistent with the present invention. As illustrated in FIG. 2, a system environment of knowledge transfer platform 110 may include a central processing unit 220, an input/output interface 230, a network interface 240, and memory 250 coupled together by a bus. Knowledge transfer platform 110 may be adapted to include the functionality and computing capabilities to utilize interactive knowledge transfer sequences in interacting with a student. Knowledge transfer platform 110 may be coupled to display 120.

As shown in FIGS. 1 and 2, knowledge transfer platform 110 may comprise a PC or mainframe computer for performing various functions and operations consistent with the invention. Knowledge transfer platform 110 may be implemented, for example, by a general purpose computer selectively activated or reconfigured by a computer program stored in the computer, or may be a specially constructed computing platform for carrying-out the features and operations of the present invention. Knowledge transfer platform 110 may also be implemented or provided with a wide variety of components or subsystems including, for example, at least one of the following: at least one central processing units 220, a co-processor, memory 250, registers, and other data processing devices and subsystems.

Knowledge transfer platform 110 may also communicate or transfer conversation sequences programs via I/O interface 230 and/or network interface 240 through the use of direct connections or communication links to other elements of the present invention. For example, a firewall in network interface 240, prevents access to the platform by unauthorized outside sources.

Alternatively, communication within knowledge transfer platform 110 may be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, knowledge transfer platform 110 may be located in the same location or at a geographically distant location from systems 120, 130, 140, and 270. Thus, knowledge transfer platform may be implemented as a client server system, where knowledge transfer platform 110 acts as a server to host multiple simultaneous knowledge transfer sessions with respective multiple students using client systems.

I/O interface 230 of the system environment shown in FIG. 2 may be implemented with a wide variety of devices to receive and/or provide the data to and from knowledge transfer platform 110. I/O interface 230 may include an input device, a storage device, and/or a network. The input device may include a keyboard, a microphone, a mouse, a disk drive, video camera, magnetic card reader, or any other suitable input device for providing data to knowledge transfer platform 110.

Network interface 240 may be connected to a network, such as a Wide Area Network, a Local Area Network, or the Internet for providing read/write access to interactive knowledge transfer sequences and data in conversation database 270.

Memory 250 may be implemented with various forms of memory or storage devices, such as read-only memory (ROM) devices and random access memory (RAM) devices. Memory 250 may also include a memory tape or disk drive for reading and providing records on a storage tape or disk as input to knowledge transfer platform 110. Memory 250 may comprise computer instructions forming: an operating system 252; a voice processing module 254 for receiving voice input from a student and for comparing the voice input to a library of phoneme-based phrases to provide one or more matching phrases; a presentation module 260 for running interactive knowledge transfer sequences (to be described in detail below); and a media play module 262 for providing multimedia objects to a student.

A conversation database 270 is coupled to knowledge transfer platform 110. Interactive knowledge transfer sequences, phoneme databases, and clips may be stored on conversation database 270. Conversation database 270 may be electronic memory, magnetic memory, optical memory, or a combination thereof, for example, SDRAM, DDRAM, RAMBUS RAM, ROM, Flash memory, hard drives, floppy drives, optical storage drives, or tape drives. Conversation database 270 may comprise a single device, multiple devices, or multiple devices of multiple device types, for example, a combination of ROM and a hard drive.

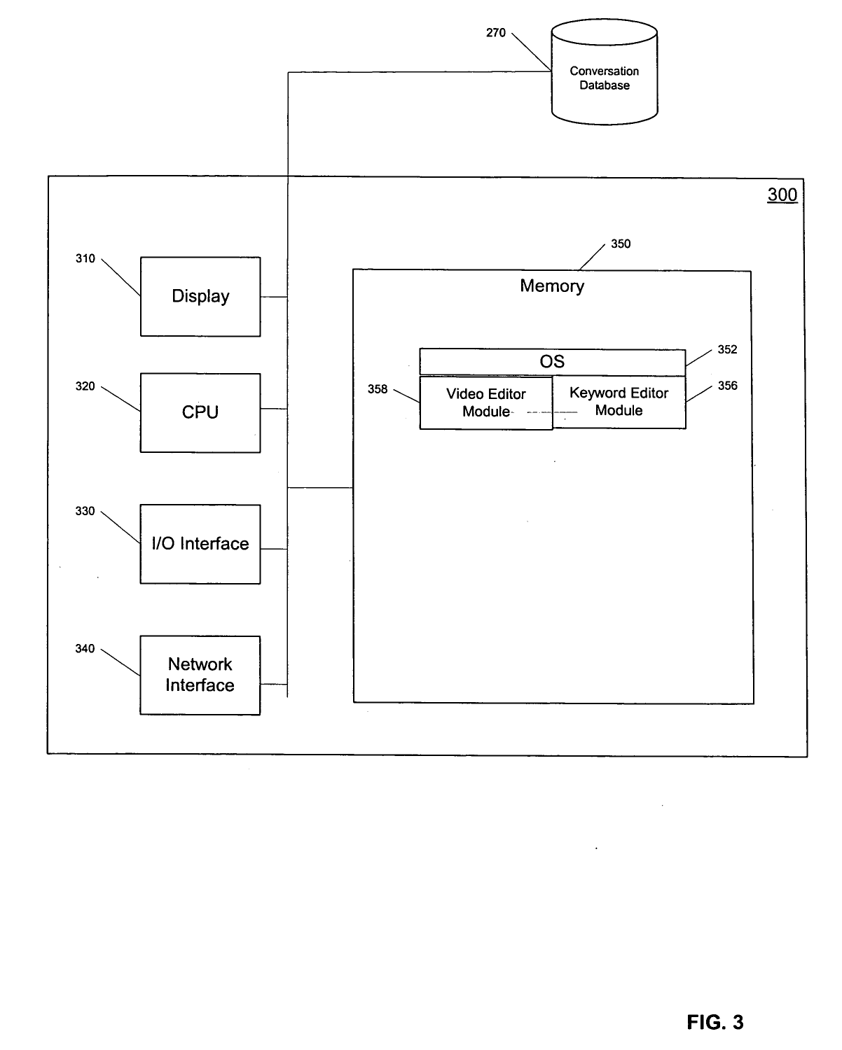

FIG. 3 is a block diagram of an authoring platform 300 consistent with the present invention. As illustrated in FIG. 3, a system environment of authoring platform 300 may include a display 310, a central processing unit 320, an input/output interface 330, a network interface 340, and memory 350 coupled together by a bus. Authoring platform 300 may be implemented on the same computer as knowledge transfer platform 110 or on a different computer. Authoring platform 300 may be adapted to include the functionality and computing capabilities to develop conversation sequences used by a knowledge transfer platform to interact with a student.

As shown in FIG. 3, authoring platform 300 may comprise a PC or mainframe computer for performing various functions and operations consistent with the invention. Authoring platform 300 may be implemented, for example, by a general purpose computer selectively activated or reconfigured by a computer program stored in the computer, or may be a specially constructed computing platform for carrying-out the features and operations of the present invention. Authoring platform 300 may also be implemented or provided with a wide variety of components or subsystems including, for example, at least one of the following: at least one central processing units 320, a co-processor, memory 350, registers, and other data processing devices and subsystems.

Alternatively, communication within authoring platform 300 may be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, authoring platform 300 may be located in the same location or at a geographically distant location from conversation database 270.

I/O interface 330 of the system environment shown in FIG. 3 may be implemented with a wide variety of devices to receive and/or provide the data to and from authoring platform 300. I/O interface 330 may include an input device, a storage device, and/or a network. The input device may include a keyboard, a microphone, a mouse, a disk drive, video camera, magnetic card reader, or any other suitable input device for providing data to authoring platform 300.

Network interface 340 may be connected to a network, such as a Wide Area Network, a Local Area Network, or the Internet for providing read/write access to interactive knowledge transfer sequences and data in conversation database 270.

Memory 350 may be implemented with various forms of memory or storage devices, such as read-only memory (ROM) devices and random access memory (RAM) devices. Memory 350 may also include a memory tape or disk drive for reading and providing records on a storage tape or disk as input to authoring platform 300. Memory 350 may comprise computer instructions forming: an operating system 352; a keyword editor module 356 for processing phrases into the library of phonemes; and a video editor module 358 for editing content clips.

Conversation database 270 is coupled to authoring platform 300. Interactive knowledge transfer sequences as described previously, phoneme databases, and clips may be stored on conversation database 270. Conversation database 270 may be electronic memory, magnetic memory, optical memory, or a combination thereof, for example, SDRAM, DDRAM, RAMBUS RAM, ROM, Flash memory, hard drives, floppy drives, optical storage drives, or tape drives. Conversation database 270 may comprise a single device, multiple devices, or multiple devices of multiple device types, for example, a combination of ROM and a hard drive.

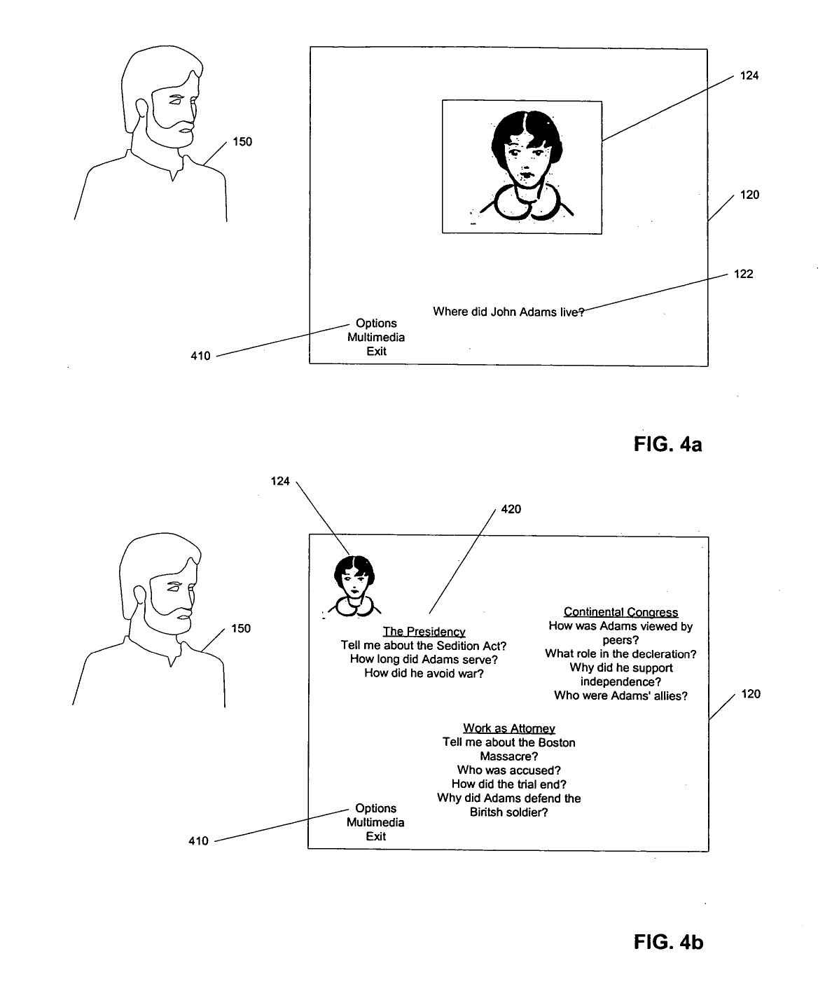

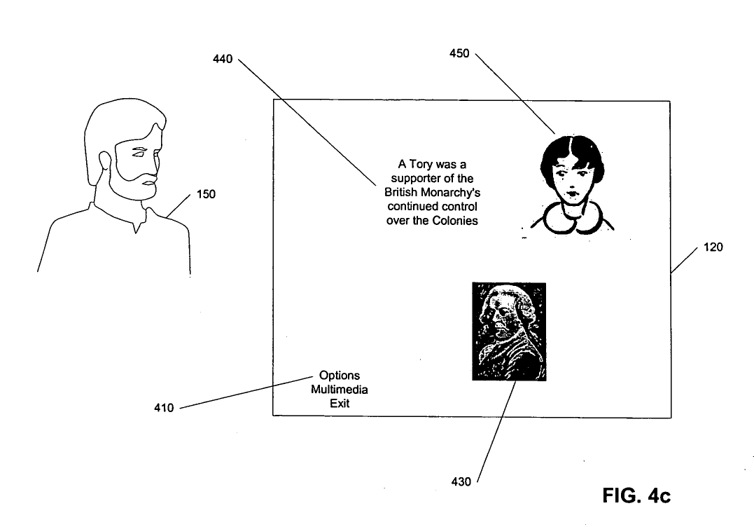

FIG. 4a is an illustration of a display screen at a prompting state consistent with the present invention. As previously described in application Ser. No. 10/438,168, student 150 may initially be presented with a display 120 having a Master Teacher 126 in a character window in a prompting state, i.e., the Master Teacher is in a neutral state awaiting a question or statement, (“phrase”) from student 150. The Master Teacher may be displayed as a still picture, or the Master Teacher may be displayed through a video clip of the Master Teacher in a generally motionless “listening” state. Student 150 may also be presented with one or more prompts, or prompting questions, 122 that may be related. Prompting questions 122 may be shown on display 120 simultaneously, for example, as a list, or may be consecutively flashed on display 120. The length that each prompting question is displayed may be based on the character length of the question. Prompts 122 assist student 150 in speaking a phrase or question that is known to an interactive knowledge transfer sequence being executed on system 100 to trigger a teaching sequence. Display 120 may also include one or more option areas 410 that display additional phrases, not related to the interactive knowledge transfer, that may be selected and spoken by student 150.

The one or more prompts 122 may be selected by selecting only those knowledge transfer questions that are appropriate during a given point in the interactive knowledge transfer. For example, some knowledge transfer questions may not be displayed until a certain content sequence is played that renders those questions relevant. In certain embodiments of the present invention, only the most relevant knowledge transfer questions are displayed in prompts 122. Each knowledge transfer question may have an associated topic and ranking. While an interactive knowledge transfer is in a topic area, the highest ranking questions in that topic area may be displayed in prompts 122. At certain points in the interactive knowledge transfer, only a single knowledge transfer question may be available for display in prompts 122, and no further lecturing may occur until student 150 asks that knowledge transfer question.

In addition, system 100 may be configured such that once a knowledge transfer question is displayed a set number of times in prompts 122, for example, three times, that knowledge transfer question is no longer displayed in prompts 122. Of course, student 150 may access this rejected question by issuing the show questions command.

When engaged with a dialog with the Master Teacher, student 150 has several options in addition to asking one of the knowledge transfer question in prompts 122. Student 150 may issue a halt command to stop playback of the currently playing content sequence. Student 150 may issue a “repeat” command to have the Master Teacher repeat the currently active content sequence from the beginning. Student 150 may provide a spontaneous question that triggers a hidden control word in system 100 to prompt playback of an associated content sequence. For example, in a knowledge transfer session with the Master Teacher on the subject of President John Adams, none of the currently displayed questions in prompts 122 may be associated with the Boston Massacre, but because the Boston Massacre is a related subject about which a student may ask, system 100 may accept Boston Massacre as a spontaneous question that triggers playback of an associated content sequence.

FIG. 4b is an illustration of a display screen during a show questions state consistent with the present invention. As previously described, student 150 may request that all available questions be displayed. Knowledge transfer question 420 may then be displayed, for example, by topic area. From this display, student 150 may ask any displayed knowledge transfer question and system 100 would display the associated content sequence and then display prompts 122 relevant to the question/content sequence's topic.

FIG. 4c is an illustration of a display screen at a lecturette state consistent with the present invention. Student 150 may also request additional information that would trigger display of additional information related to the content sequence that is currently playing or has most recently been played. Additional information may include, for example, multimedia clips, links to Internet resources, or a glossary. A request for additional information may be received and acted upon not only during the playing of a lecturette, but also during playback of a knowledge transfer content sequence.

Student 150 may also request the playing of a lecturette 450. Lecturette 450 is a self-contained short lecture about a related topic that does not require interaction from student 150. During lecturette 450, a student may halt and continue lecturette 450 or request system 100 to return to the Master Teacher dialog. Also during lecturette 450, system 100 may display unobtrusive text 440 or visuals 430 on display 120.

In any of the above sequences, system 100 may remove the prompts 122 or option menus 410, 420 from display 120 during the speech state, so as to enhance the impression of being in an actual conversation.

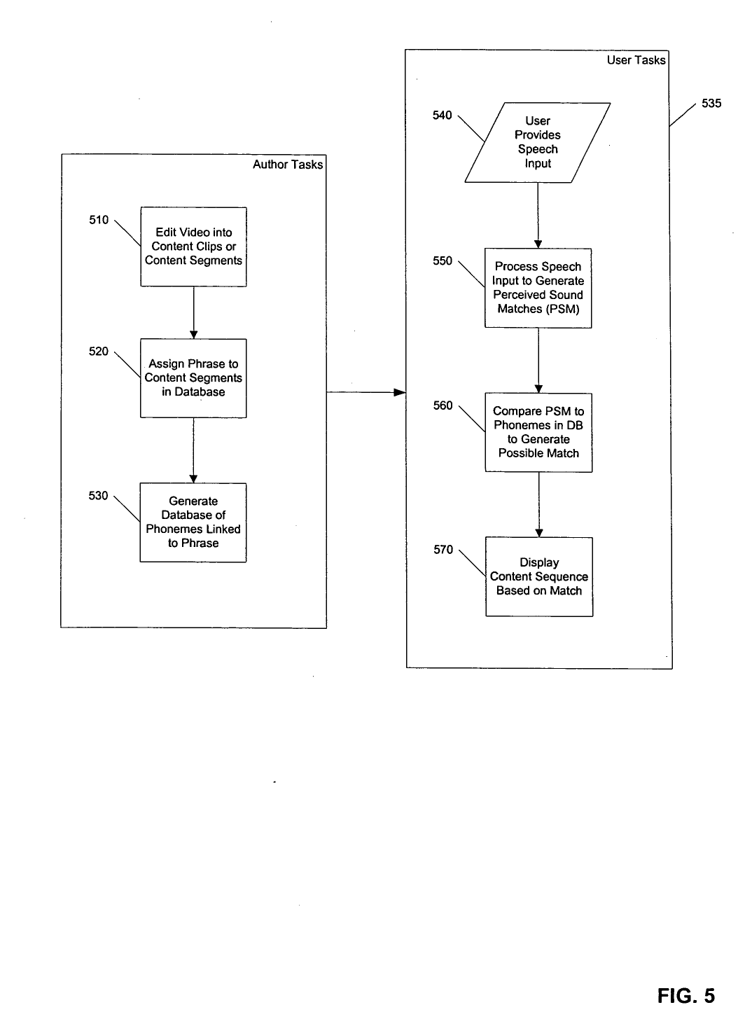

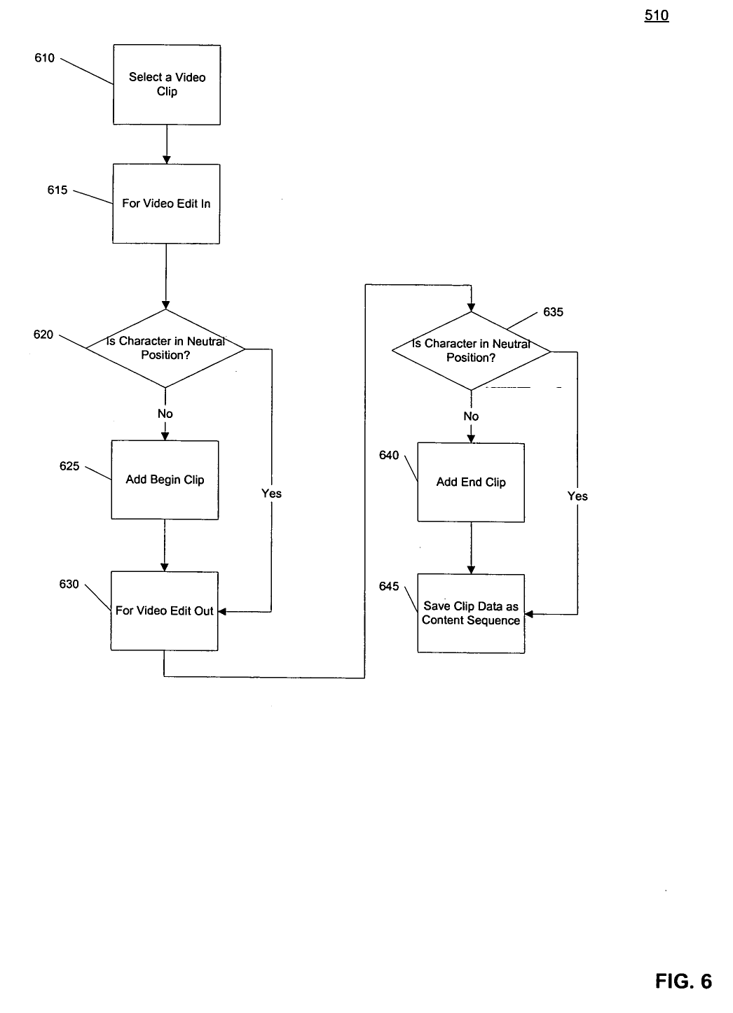

FIG. 5 is a flowchart of an author process and a student interaction process consistent with the present invention. The author process may comprise stages 510, 520 and 530, which may be executed in any order. The author processes may be executed on authoring platform 300. At stage 510, the author may edit signals from one or more video sources into knowledge transfer content sequences. Knowledge transfer content sequences may be generated from a video source, such as a video camera recording of a human Master Teacher, and saved as individual video files, or knowledge transfer content sequences may comprise a designated start frame and a designated end frame within a video file to form knowledge transfer content sequences including content clips, begin clips, and end clips. The author may designate the start frame and the end frame, whereby a pair of values designating the start frame and end frame is stored as designation data of the examination content sequences. Generate knowledge transfer content sequence process 510 will be explained more fully with respect to FIG. 6.

At stage 520, the author assigns one or more questions to each knowledge transfer content sequence. Each question may be linked to one or more question phrases. As a question phrase is assigned to a knowledge transfer content sequence, the phrase may be stored in the conversation database.

At stage 530, the author may execute a phoneme generation process which takes one or more question phrases associated with a question and generates a list of phonemes associated with the question phrases. This may enhance the speed of the matching process, so that the execution of the interactive knowledge transfer sequence with the student proceeds promptly and with little delay. As is known to those of ordinary skill in the art, phonemes are units of specific sound in a word or phrase. For example, “Bull” in “Bullet,” “Kashun” in “Communication,” and “Cy” and “Run” in “Siren.”

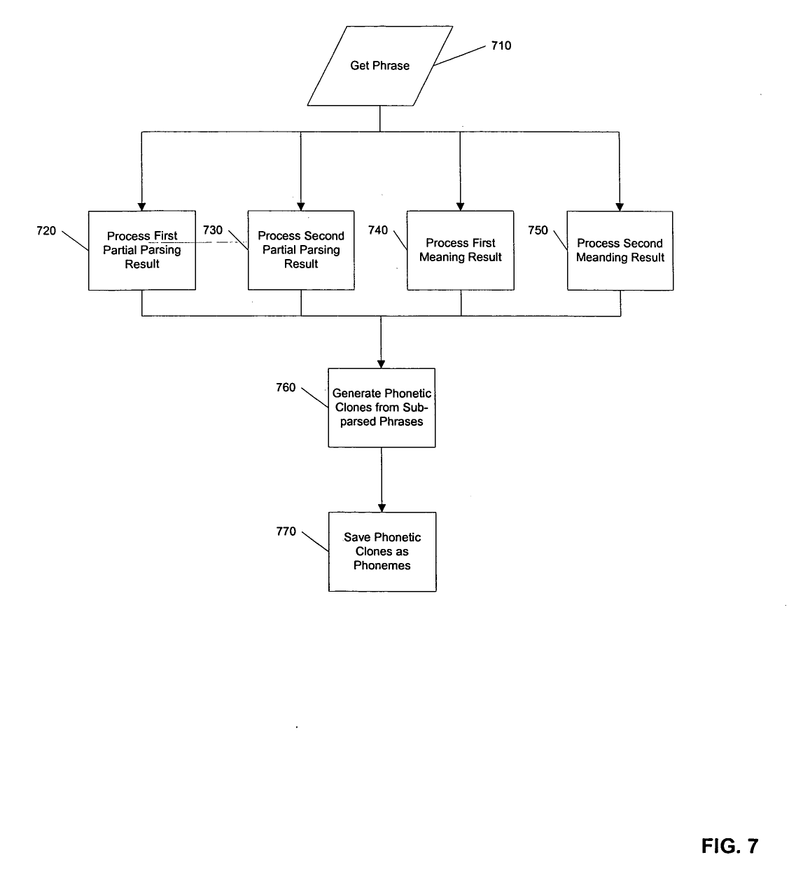

Phonemes may be generated based on portions of the question phrase, a key word and synonyms of the key word in the question phrase, or a qualifier and synonyms of the qualifier in the question phrase. The phoneme generation process is explained more fully in FIG. 7. The end product of the author tasks is a data file known as an interactive knowledge transfer program, which may be stored in the conversation database.

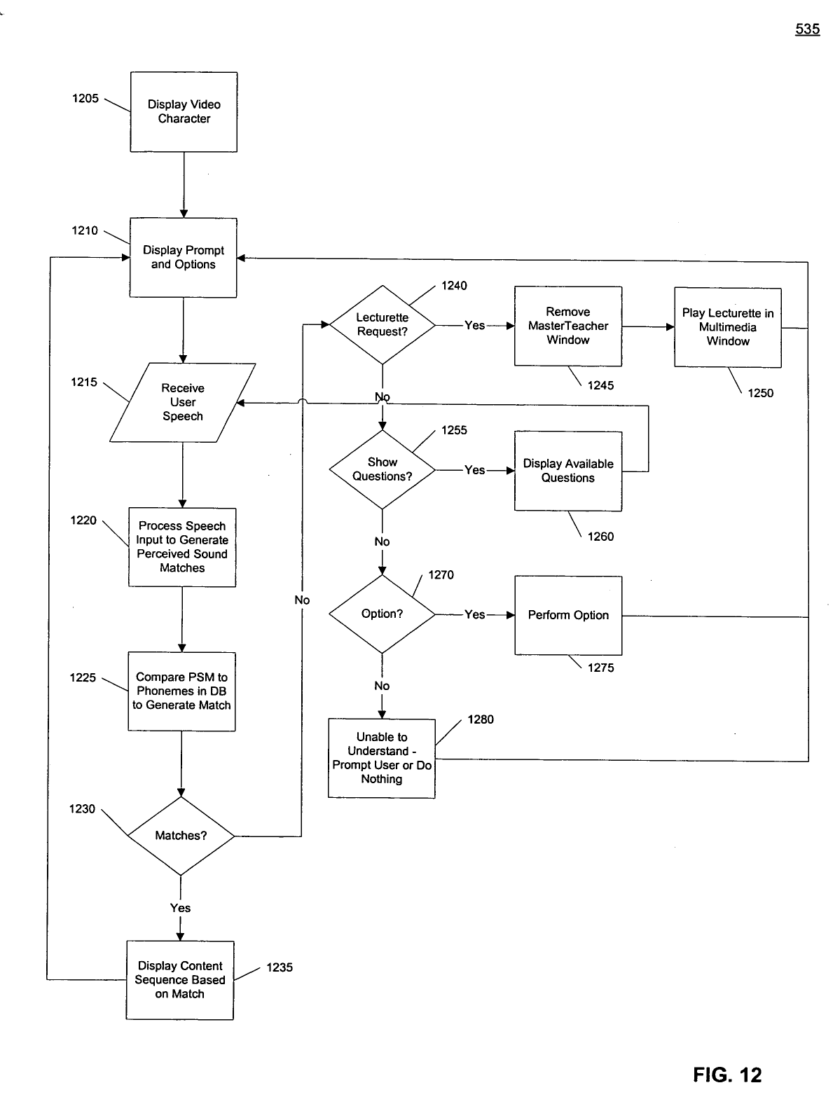

Student tasks 535 are those tasks associated with the execution of the interactive knowledge transfer program in system 100 (FIG. 1). At stage 540, the student has begun a knowledge transfer session and a knowledge transfer content sequence associated with a question is displayed to the student via display 120 and speakers 130. In an exemplary embodiment, the Master Teacher appears in the dialogue window of display 120. At stage 550, the student provides a question as input to interactive system 100 by speaking into microphone 140 (FIG. 1). At stage 560, interactive system 100 processes the input speech to generate one or more perceived sound matches (“PSMs”). At stage 570, the appropriate associated content sequence is played back. Student tasks process 535 is explained in more detail with respect to FIG. 12.

FIG. 6 is a flowchart of a knowledge transfer content sequence generation process 510 (FIG. 5) consistent with the present invention. At stage 610, an author selects a video clip from a plurality of stored multimedia files. The stored multimedia files may be, for example, raw video clips generated by the taping of a Master Teacher during an interview process. Raw video clips may be captured to magnetic or optical storage media in, for example, Digital Video (DV) format from source footage of master tapes from an original Master Teacher interview. These raw video clips may be compressed using software or hardware digital video codecs such as MPEG3 or MPEG4 standard to form content clips for storage in database 270. The content clips stored in the database may be indexed by Master Teacher and stored in the compressed state.

The selection of stage 610 may be performed by selecting a start frame and an end frame for the content clip. At stage 615, the process begins for video edit in, i.e., for the start frame designation. At stage 620, the process checks to see if the Master Teacher is not in a neutral position in the start frame, for example, if the Master Teacher's mouth is open or if the Master Teacher's face is close to the edge of the visual frame. If the Master Teacher is not in a neutral position in the start frame, the process, at stage 625, selects a begin clip for frame matching.

The begin clip consists of a short transitional video sequence of the Master Teacher moving from a neutral position to the position of the Master Teacher in the start frame of the content, or a position close thereto. The process may select from multiple begin clips to select the one with the best fit for the selected content clip. Begin clips may be run in forward or reverse, with or without sound, whichever is better for maintaining a smooth transition to the start frame of the content clip. The begin clip may be physically or logically added to the start of the content clip to form a content sequence. For example, the content sequence may be saved in a file comprising the begin clip and video clip. Or, the begin clip may be designated by a begin clip start frame and a begin clip end frame which may be stored along with the information specifying the content clip start frame and the content clip end frame. Thus, the content sequence data record may comprise the following fields: begin clip file name, begin clip start frame, begin clip stop frame, content clip file name, content clip start frame, and content clip end frame.

At stage 630, the process begins for video edit out, i.e., for the stop frame designation. At stage 635, the process checks to see if the Master Teacher is at a neutral position in the stop frame. If the Master Teacher is not in a neutral position in the stop frame, the process, at stage 640, selects an end clip for frame matching. The end clip serves as a transitional clip to a neutral position from the position of the Master Teacher in the stop frame, or a position close thereto. The process may select from multiple end clips to select the one with the best fit. End clips may be run in forward or reverse, with or without sound, whichever is better for maintaining a smooth transition to the start frame. The end clip may be physically or logically added to the start of the content clip. For example, the content sequence may be saved in a file comprising the end clip and content clip. Alternatively, the end clip may be designated by an end clip start frame and an end clip end frame which may be stored along with the information regarding the content clip start frame and the content clip end frame. Thus, the content sequence data record may comprise the following fields: content clip file name, content clip start frame, content clip end frame, end clip file name, end clip start frame, and end clip stop frame.

Where both begin clips and end clips are utilized, the content sequence data record may comprise the following fields: begin clip file name, begin clip start frame, begin clip stop frame, content clip file name, content clip start frame, content clip end frame, end clip file name, end clip start frame, and end clip stop frame. Thus, a knowledge transfer content sequence may be generated for one or more questions and saved (stage 645).

FIG. 7 is a flowchart of a phoneme generating process 530 (FIG. 5) consistent with the present invention. This process may be used by the author to generate a table of phonemes associated with a question associated with a knowledge transfer content sequence. At stage 710, the process retrieves the question to be processed in the form of a text file. Next, the process may implement one or more stages of phrase processing to generate groups of sub-parsed phrases.

Various types of phrase processing may be implemented. In the present embodiment, four phrase processing stages are executed. Specifically, two syntax-based stages, partial parsing stages 720 and 730, are executed and two meaning-based stages, association stages 740 and 750, are executed. Each of these stages yields sub-parsed phrases of the associated phrase.

At stage 760, phonetic clones may be generated of the sub-parsed phrases returned from stages 720-750. Phonetic clones are the phonetic spellings of the sub-parsed phrases or terms. To generate phonetic clones, the author may consider each answer phrase and anticipate the various ways that a student could paraphrase the answer phrase. The author then may anticipate the various ways that a student might pronounce the answer phrase. The author may then develop phonemes as needed for optimal recognition. Phonemes are applied to account for the differences between written and spoken language. For example, “your wife” when spoken will often sound like “urwife,” as if it were a single word. The articulation of both words in “your wife” would be unusual in natural conversation. Unless a phoneme is used to alert the system of such natural speech habits, recognition may be made more difficult, though not impossible, and the continuity of the knowledge transfer dialogue may be disrupted.

To illustrate some further example of the process, sub-parsed phrase “in school” may yield the phonetic clones “enskool” and “inskul,” “when you married” may yield “winyoomarried” and wenyamarried,” and “to college” may yield “tuhcallidge” and toocawlige.” At stage 770, the phonetic clones are saved in a phoneme data file as a phoneme text file associated with the answer. At stage 780, the generated phonemes are linked to the answer.

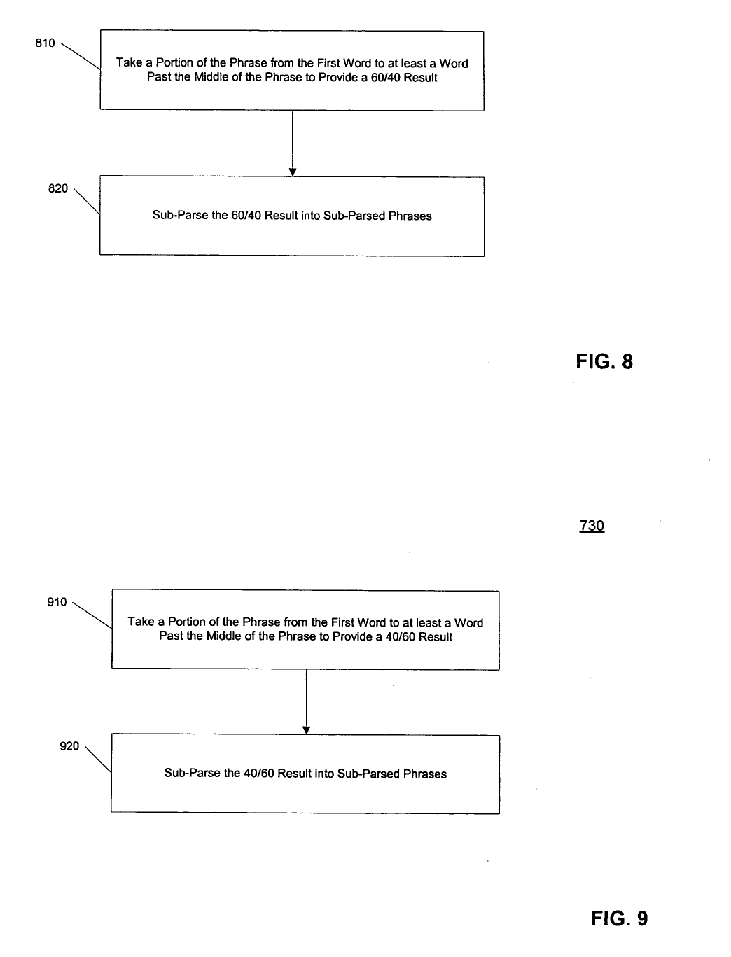

FIG. 8 is a flowchart of first partial processing stage 720 consistent with the present invention. Stage 720 is a partial processing stage, specifically, a “60/40” parsing stage, that is 60%/40%. At stage 810, a majority of the associated answer phrase, beginning with the first word of the phrase is parsed from the phrase. For example, the answer phrase “He was born in Saudi Arabia” may be 60/40 parsed as “He was born in.” At stage 820, the 60/40 result is sub-parsed into one or more sub-phrases. For example, sub-parsing the 60/40 parsed phrase “He was born in” may yield sub-parsed phrases “he was,” “born in,” and “was born,” each consisting of at least half of the parsed phrase “He was born in” and each beginning with a different word counted from the beginning of the parsed phrase.

FIG. 9 is a flowchart of second partial processing stage 730 consistent with the present invention. Stage 730 is a partial parsing stage similar to stage 720 (FIG. 8), except that parsing begins from the end of the associated phrase, rather than the beginning as in stage 720. Stage 730 is referred to as a “40/60” stage. Thus, at stage 910, a majority of the associated phrase, ending with the last word of the phrase is parsed from the phrase. For example, the phrase “He was born in Saudi Arabia” may be 40/60 parsed as “was born in Saudi Arabia.” At stage 920, the 40/60 result is sub-parsed into one or more phrases. For example, sub-parsing the 40/60 phrase “was born in Saudi Arabia” may yield the sub-parsed phrases “was born,” “Saudi Arabia,” and “born in.”

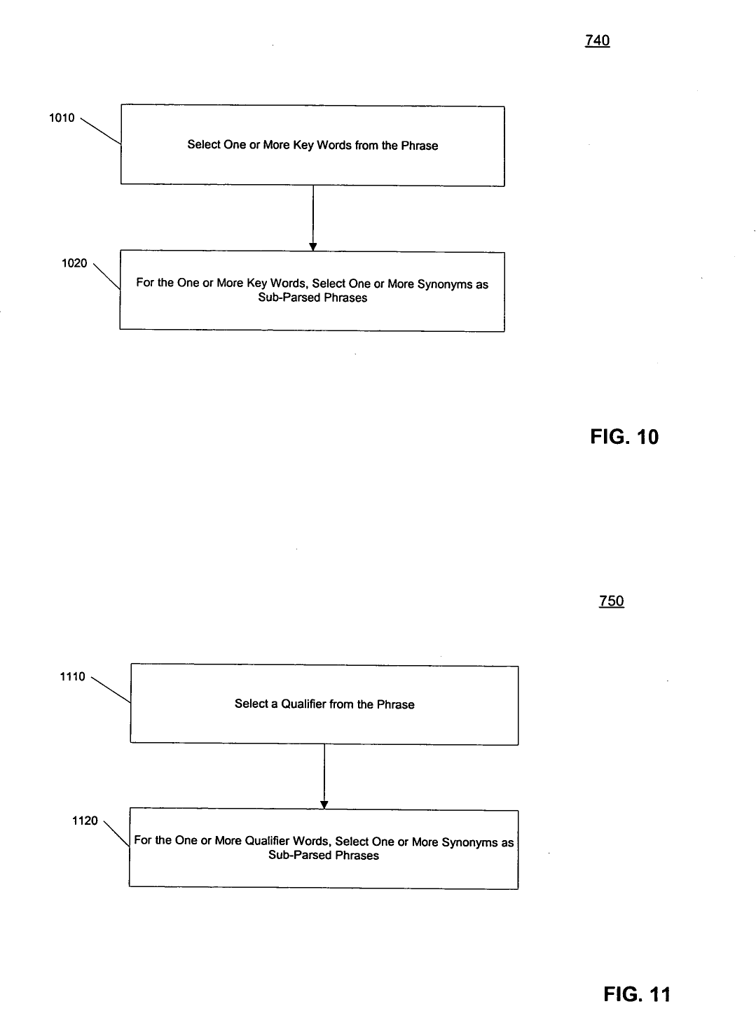

FIG. 10 is a flowchart of first meaning-based process, association process 740, consistent with the present invention. Specifically, 740 is a type of meaning-based process known as a “keyword” process. Keywords may be nouns or noun phrases that depict a central topic or idea of an answer. For example, for the phrase “He was born in Saudi Arabia” a keyword might be “Saudi Arabia.” At stage 1010, one or more keywords are selected from the associated phrase, based on meanings of words in the associated phrase. At stage 1020, terms with similar meaning may be generated for the keyword. For example, the keyword “Saudi Arabia” may yield, “Arabia,” “Saudi,” and “Riyad.”

FIG. 11 is a flowchart of second meaning-based process 750 consistent with the present invention, based on “qualifiers.” Qualifiers may be adjectives or adjective phrases that modify the intention or meaning of an answer. For example, in the answer “He was born in Saudi Arabia” the keyword is “Saudi Arabia” and the qualifier is “was born.”

At stage 1110, one or more qualifiers are selected from the answer phrase. For example, for the answer phrase “He was born in Saudi Arabia” a qualifier might be “born in.” At stage 1020, synonyms may be generated for the qualifier. For example, the qualifier “born in” may yield, for example, the synonyms “raised,” “was from,” “nurtured.”

FIG. 12 is a flowchart of a knowledge transfer process consistent with the present invention. At stage 1205, the Master Teacher may be displayed in a neutral position on the display awaiting a question from the student. The Master Teacher may be displayed as a still picture, or the Master Teacher may be displayed through a content clip of the Master Teacher in a “listening” state. At stage 1210, one or more prompts, or questions, may be displayed, and one or more options may be displayed. Options may include, for example: “Begin the session”; “Repeat that please”; and “Halt.”

At stage 1215, an utterance from a student is received. At stage 1220, the utterance is processed to generate a list of perceived sound matches (“PSM”) in the form of text. At stage 1225, the PSM are compared to the library of stored phonemes, also in text form, to generate a list of matches. The phonemes in the library that match the utterance are selected and prioritized according to the closeness of the sound match on the basis of scores. A predetermined number of these prioritized phonemes may be passed to the system for scoring to determine whether a valid recognition has occurred. The score of each phoneme may be arrived at by multiplying the number of discernable letters in the PSM by a priority number set by the author. The sum of all of the products from the matches to the utterances may be utilized to determine if a recognition, or match, has occurred. (stage 1230). A match occurs if the sum is equal to or greater than a threshold level set by the author.

If a match occurs, at stage 1235, the linked content clip is displayed to the student. If a match is not made, at stage 1240, a check is made to see if the utterance was a lecturette request. If so, at stage 1245, the Master Teacher dialogue window may be adjusted, and, at stage 1250, a lecturette window may display the Master Teacher delivering the lecturette to the student. During the lecturette, unobtrusive text or visuals may be displayed on display 120 to support what is being taught in the lecturette. Following stage 1250, the system returns to the prompting state at stage 1210.

If the utterance was not a lecturette request, at stage 1255 a check is made to see if the utterance was a show questions request. If so, at stage 1260, a listing of available questions is displayed. Following stage 1260, the system returns to the receive utterance state at stage 1215.

At stage 1270, a check is made to see if the utterance was a request for another option. If so, at stage 1275, the option is executed. For example, the utterance may be a request to repeat the last content segment from the Master Teacher. If so, the last knowledge transfer sequence given by the Master Teacher is repeated by replaying the video clip. As another example, the request may be to perform a session review. If so, a list of all the knowledge transfer questions asked by the student is displayed for the student. Following stage 1275, the system returns to the prompting state at stage 1210.

If none of these situations matches, at stage 1280, the system determines that it cannot process the utterance. At this stage, the system may return to stage 1210 or the system may play a content sequence whereby the Master Teacher states that he cannot understand the question. For example, the Master Teacher may state “I'm sorry. I didn't understand your question,” or “I'm having trouble hearing you, will you please repeat your question?”

At any point in time in the above described process, the student may halt the process by issuing an utterance, such as “Stop.” This utterance is processed by the system and recognized as a command to halt the process. Halting the process may return the process to stage 1210. While halting the Master Teacher, the process may attempt to not compromise the believability of the situation by returning the Master Teacher to the neutral position. The process may also utilize aspects of the end clip associated with the playing video clip to maintain believability. For example, the process may take one or more frames from the end of the content clip and one or more frames from the end of the end clip and utilize these frames to transition the Master Teacher to the neutral position.

Those skilled in the art will appreciate that all or part of systems and methods consistent with the present invention may be stored on or read from other computer-readable media, such as: secondary storage devices, like hard disks, floppy disks, and CD-ROM; a carrier wave received from the Internet; or other forms of computer-readable memory, such as read-only memory (ROM) or random-access memory (RAM).

Furthermore, one skilled in the art will also realize that the processes illustrated in this description may be implemented in a variety of ways and include multiple other modules, programs, applications, sequences, processes, threads, or code sections that all functionally interrelate with each other to accomplish the individual tasks described above for each module, sequence, and daemon. For example, it is contemplated that these programs modules may be implemented using commercially available software tools, using custom object-oriented, using applets written in the Java programming language, or may be implemented as with discrete electrical components or as at least one hardwired application specific integrated circuits (ASIC) custom designed just for this purpose.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

1. A method for providing knowledge transfer between a Master Teacher and a student, comprising:
providing a prompting question to the student, wherein the prompting question is selected from one or more knowledge transfer questions;
receiving an utterance from the student;
determining if a match exists between the utterance and the prompting question; and
if a match exists, playing a knowledge transfer content sequence associated with the matched prompting question.

2. The method of claim 1 wherein the prompting question is one of a sequence of prompting questions selected from the one or more knowledge transfer questions, and further wherein the prompting question is displayed as a timed rotation of the sequence of prompting questions.

3. The method of claim 2, wherein the sequence of prompting questions are selected based on their relevance to a topic being currently covered by the Master Teacher.

4. The method of claim 2, wherein once a prompting question from the sequence of prompting questions is displayed a predetermined number of times, the prompting question is removed from the sequence of prompting questions and will not be further displayed as a prompting question to the student.

5. The method of claim 1, further comprising logging the prompting questions uttered by the student.

6. The method of claim 5, wherein the utterance received from the student is a request to review the session and further wherein, in response, the logged prompting questions are displayed to the student.

7. The method of claim 6, further comprising receiving a further utterance from the student, matching the further utterance to one of the displayed logged prompting questions, and playing a knowledge transfer content sequence associated with the matched displayed logged prompting question to the student.

8. The method of claim 5, further comprising removing the prompting question from the sequence of prompting questions after a match occurs between the prompting question and the utterance.

9. The method of claim 8, wherein the utterance received from the student is a request to show the knowledge transfer questions, and further comprising displaying all knowledge transfer questions that have not yet been uttered by the student and that are potentially available as one of the sequence of prompting questions.

10. The method of claim 2, wherein the sequence of prompting questions is limited to a single prompting question, so that the interactive knowledge transfer may not continue unless the student utters the single prompting question.

11. The method of claim 2, wherein the utterance received from the student is a spontaneous question not among the sequence of prompting questions, and wherein the method further comprises:
matching the utterance with a spontaneous question; and
playing a content clip associated with the spontaneous question.

12. The method of claim 1, wherein the utterance is matched to a request for additional information, and further comprising displaying options for further information to the student.

13. The method of claim 12, wherein the further information is selected from a multimedia clip, a link to an Internet web site, or an object.

14. The method of claim 1, wherein the utterance is matched to a request to repeat the previously displayed knowledge transfer content sequence, and, if so, playing the previously displayed knowledge transfer content sequence.

15. The method of claim 1, wherein the utterance is matched to a request for a lecturette, and, if so, adjusting the Master Teacher display and playing a lecturette.

16. The method of claim 15, further comprising displaying unobtrusive text along with the display of the lecturette.

17. The method of claim 1, further comprising:
providing a prompting question to a second student, wherein the prompting question is selected from one or more knowledge transfer questions;
receiving an utterance from the second student;
determining if a match exists between the utterance from the second student and the prompting question; and
if a match exists, playing for the second student a knowledge transfer content sequence associated with the matched prompting question.

18. A system for providing knowledge transfer between a Master Teacher and a student, the system comprising:
a display for displaying the Master Teacher;
a memory; and
a processor, coupled to the memory and the display, the processor operable to:
provide a prompting question to the student, wherein the prompting question is selected from one or more knowledge transfer questions;
receive an utterance from the student;
determine if a match exists between the utterance and the prompting question; and
if a match exists, playing a knowledge transfer content sequence associated with the matched prompting question.

19. The system of claim 18 wherein the prompting question is one of a sequence of prompting questions selected from the one or more knowledge transfer questions, and further wherein the prompting question is displayed as a timed rotation of the sequence of prompting questions.

20. The system of claim 19, wherein the sequence of prompting questions is selected based on their relevance to a topic being currently covered by the Master Teacher.

21. The system of claim 19, wherein once a prompting question from the sequence of prompting questions is displayed a predetermined number of times, the prompting question is removed from the sequence of prompting questions and will not be further displayed as a prompting question to the student.

22. The system of claim 18, wherein the processor is further operable to log the prompting questions uttered by the student.

23. The system of claim 22, wherein the utterance received from the student is a request to review the session and further wherein, in response, the processor is operable to display the logged prompting questions to the student.

24. The system of claim 23, wherein the processor is further operable to:
receive a further utterance from the student;
match the further utterance to one of the displayed logged prompting questions; and
play a knowledge transfer content sequence associated with the matched displayed logged prompting question to the student.

25. The system of claim 22, wherein the processor is further operable to remove the prompting question from the sequence of prompting questions after a match occurs between the prompting question and the utterance.

26. The system of claim 25, wherein the utterance received from the student is a request to show the knowledge transfer questions, and further wherein the

26. The system of claim 25, wherein the utterance received from the student is a request to show the knowledge transfer questions, and further wherein the processor is operable to display all knowledge transfer questions that have not yet been uttered by the student and that are potentially available as one of the sequence of prompting questions.

27. The system of claim 19, wherein the sequence of prompting questions is limited to a single prompting question, so that the interactive knowledge transfer may not continue unless the student utters the single prompting question.

28. The system of claim 19, wherein the utterance received from the student is a spontaneous question not among the sequence of prompting questions, and wherein the processor is further operable to:
match the utterance with a spontaneous question; and
play a content clip associated with the spontaneous question.

29. The system of claim 18, wherein the utterance is matched to a request for additional information, and further wherein the processor is operable to display options for further information to the student.

30. The system of claim 29, wherein the further information is selected from a multimedia clip, a link to an Internet web site, or an object.

31. The system of claim 18, wherein the processor is further operable to match the utterance to a request to repeat the previously displayed knowledge transfer content sequence, and, if so, play the previously displayed knowledge transfer content sequence.

32. The system of claim 18, wherein the processor is further operable to match the utterance to a request for a lecturette, and, if so, adjusting the Master Teacher display and playing a lecturette.

33. The system of claim 32, wherein the processor if further operable to display unobtrusive text along with the display of the lecturette.

34. The system of claim 18, wherein the processor is further operable to:
provide a prompting question to a second student, wherein the prompting question is selected from one or more knowledge transfer questions;
receive an utterance from the second student;
determine if a match exists between the utterance from the second student and the prompting question; and
if a match exists, play for the second student a knowledge transfer content sequence associated with the matched prompting question.
